(19) United States
(12) Patent Application Publication
(10) Pub. No.: US 2014/0188637 A1
(43) Pub. Date: Jul. 3, 2014

(54) AUTOMATED DELIVERY SYSTEM

(71) Applicants: Sezhiyan Balasubramaniam, Fremont, CA (US); Yoganandh Ettiyappan, Sunnyvale, CA (US); Venkatachalam Rangasamy, San Jose, CA (US); Matthew May, Omaha, NE (US); Preeti Maheshwari, Fremont, CA (US)

(72) Inventors: Sezhiyan Balasubramaniam, Fremont, CA (US); Yoganandh Ettiyappan, Sunnyvale, CA (US); Venkatachalam Rangasamy, San Jose, CA (US); Matthew May, Omaha, NE (US); Preeti Maheshwari, Fremont, CA (US)

(21) Appl. No.: 14/079,416

(22) Filed: Nov. 13, 2013

Related U.S. Application Data
(60) Provisional application No. 61/748,715, filed on Jan. 3, 2013.

(51) Int. Cl. G06Q 50/12; G06Q 30/06

(52) U.S. Cl. CPC G06Q 50/12; G06Q 30/0633
USPC 705/15

(57) ABSTRACT

Methods and systems for automated delivery are described. A user submits an order for an item that is to be picked up. The order is processed, the item is placed in a container, and a notification is sent to the user with delivery details, such as a container identifier, pick up location, and pick up time. The user provides information associated with the order or his or her identity, such as a credit card, to gain access to the item in the container.

### CROSS-REFERENCE TO RELATED APPLICATION

Pursuant to 35 U.S.C. §119(e), this application claims priority to the filing date of U.S. Provisional Patent Application No. 61/748,715, filed Jan. 3, 2013, which is incorporated by reference in its entirety.

### BACKGROUND

1. Technical Field

The present invention generally relates to delivery systems, and in particular, to automated delivery systems.

2. Related Art

Restaurants and other food service entities spend a lot of time taking a food order, preparing the food, and delivering the food to the customer. It has become a common practice for customers to order food online, e.g., pizza, and pick up the order from the store or restaurant. The pick-up order item is then delivered to the customer in the store once the customer provides some sort of identification, such as a name or phone number.

Employees of the store are typically occupied with the food preparation, especially during peak demand hours and become too busy to answer the delivery request or forget to alert the customer with a “food ready” notification. Consequently, customers may be put on hold for unacceptable periods of time, even after the food is ready for pick-up. Therefore, a need exists to improve food delivery to customers.

### BRIEF DESCRIPTION OF THE DRAWINGS

FIG. 1 is a block diagram illustrating a system for automated delivery according to an embodiment of the present disclosure;

FIG. 2 is a flowchart showing a method for automated delivery according to an embodiment of the present disclosure; and

FIG. 3 is a block diagram of a system for implementing a device according to an embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure describes an automated delivery system that delivers pick-up orders to the appropriate user with reduced manual intervention. Each pick-up item may have a bar code. A centralized delivery unit is programmed to automatically read the bar code from the pick-up item, assign a particular container to a particular order, and send an email, text, or voice notification to a user with the corresponding container number or ID and any other location information, such as building number. Boxes or lockers may have smart card access and an electronic display of the user name or other user identifier to avoid false delivery. The user collects the pick-up item from the appropriate container in the centralized delivery unit by entering information associated with the order (e.g., order number) or a user identifier, such as by swiping a smart card, a driver's license, an ID card, a credit card, a bank card, or through an NFC communication with the user smart phone (e.g., through a tap). The pick-up item may be a food item, mail, or any other item suitable for user pick-up.

As such, the system eliminates the need for expensive and time-consuming manual delivery to each customer and frees store employees from delivery, thereby enabling those employees to concentrate on the food preparation and/or other tasks, and/or reduces reliance on employees.

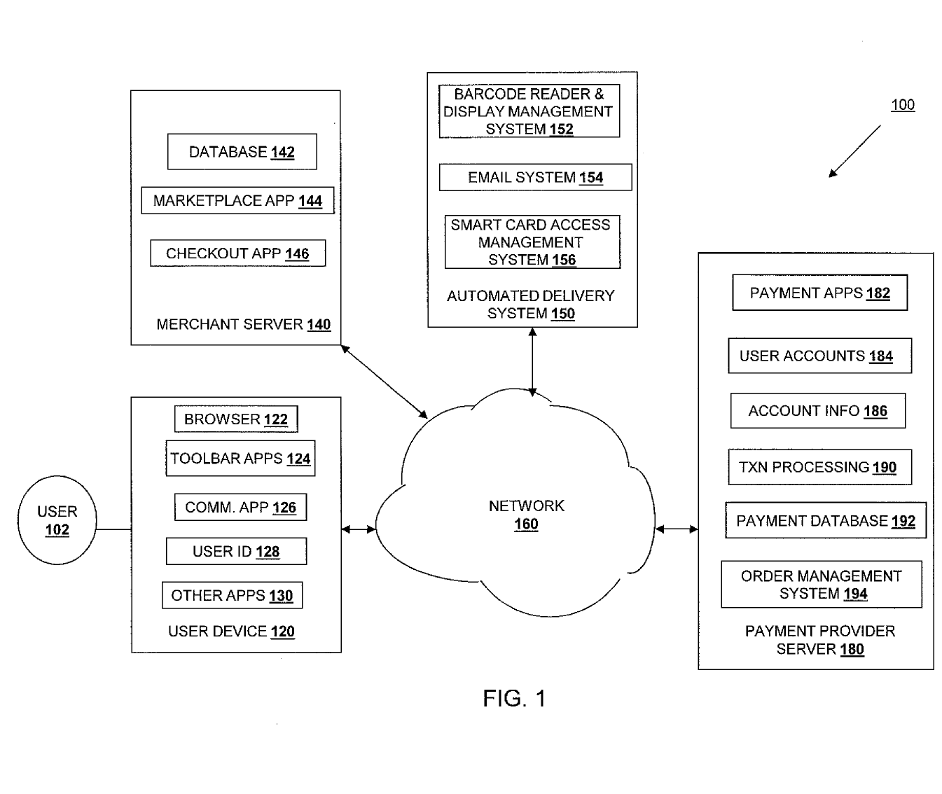

FIG. 1 is an illustration of a system 100 used for automated delivery according to one embodiment. System 100 includes a user device 120, a merchant device or server 140, an automated delivery system 150, and a payment provider server 180, in communication over a network 160. Payment provider server 180 may be maintained by a payment provider, such as PayPal, Inc. of San Jose, Calif. A user 102, such as a consumer, utilizes user device 120 to make a purchase transaction facilitated by payment provider server 180, with one or more merchants, such as purchase and delivery/pick-up of an order.

User device 120, merchant server 140, automated delivery system 150, and payment provider server 180 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160.

Network 160 may be implemented as a single network or a combination of multiple networks. For example, in various embodiments, network 160 may include the Internet or one or more intranets, landline networks, wireless networks, and/or other appropriate types of networks.

User device 120 may be implemented using any appropriate hardware and software configured for wired and/or wireless communication over network 160. For example, in one embodiment, the user device 120 may be implemented as a personal computer (PC), a smart phone, personal digital assistant (PDA), laptop computer, and/or other types of computing devices capable of transmitting and/or receiving data, such as an iPad™ from Apple™.

User device 120 may include one or more browser applications 122 which may be used, for example, to provide a convenient interface to permit user 102 to browse information available over network 160. For example, in one embodiment, browser application 122 may be implemented as a web browser configured to view information available over the Internet or access a website or app of the payment provider or merchant. User device 120 may also include one or more toolbar applications 124 which may be used, for example, to provide client-side processing for performing desired tasks in response to operations selected by user 102. In one embodiment, toolbar application 124 may display a user interface in connection with browser application 122.

User device 122 may further include other applications 130 as may be desired in particular embodiments to provide desired features to user device 120. For example, other applications 130 may include security applications for implementing client-side security features, programmatic client applications for interfacing with appropriate application programming interfaces (APIs) over network 160, or other types of applications. Applications 130 may also include email, texting, voice and IM applications that allow user 102 to send and receive emails, calls, texts, and other notifications through network 160. User device 120 includes one or more user identifiers 128 which may be implemented, for example, as operating system registry entries, cookies associated with browser application 122, identifiers associated with hardware of user device 120, or other appropriate identifiers, such as used for payment/user/device/order authentication or identification. In one embodiment, user identifier 128 may be used by a payment service provider to associate user 102 with a particular account maintained by the payment provider. A communications application 126, with associated interfaces, enables user device 120 to communicate within system 100.

Merchant server 140 may be maintained, for example, by a merchant or seller offering various items, products and/or services through an online site or app. In an embodiment, the merchant is a restaurant or café. Generally, merchant server 1040 may be maintained by anyone or any entity that provides items for pick-up to consumers. Merchant device 140 includes a database 142 for identifying available products and/or services (e.g., collectively referred to as items) which may be made available for viewing and purchase by user 102. Merchant server 140 also includes a marketplace application 144 which may be configured to serve information over network 160 to browser 122 of user device 120 and/or payment provider server 180. In one embodiment, user 102 may interact with marketplace application 144 to view various items available for purchase from the merchant.

Merchant server 140 also includes a checkout application 146 which may be configured to facilitate the purchase by user 102 of goods or services identified by marketplace application 144. Checkout application 146 may be configured to accept payment information from or on behalf of user 102 through payment service provider server 180 over network 160. For example, checkout application 146 may receive and process a payment confirmation from payment service provider server 180, as well as transmit transaction information to the payment provider and receive information from the payment provider (e.g., a transaction/order ID and order pick-up information). Checkout application 146 may also be configured to accept one or more different funding sources for payment.

Automated delivery system 150 may be maintained, for example, by a service provider, or a company specializing in delivery of goods and/or services. Automated delivery system 150 includes a barcode reader and display management system 152, an email system 154, and a smart card access management system 156.

The barcode reader system 150 reads the barcode from a pick-up box and gets the information about a pick-up order from an order management system (e.g., order management system 194) to verify the quantities associated with the order and assign a particular box to a particular order. The user's name or other identifier, such as a phone number, may be displayed in the associated box once the particular box is assigned to an item. Barcodes may also include QR codes or other machine readable images.

The email system 154 may generate a delivery confirmation email to the user 102 with details like building number, box number, and access code. The email system 154 may obtain assigned box details from order management system 194 based on an order ID. The confirmation may include other order details as well, such as when the order will be ready. In some embodiments, the email is sent prior to the order being ready to give the user 102 time to get to the pick-up location. Also, in other embodiments, notification can be sent through text or voice, such as to a user's mobile device or PC. In some embodiments, the email system 154 generates the email, but order management system 194 sends the email to the user 102. Updates may be transmitted to the user device as needed, such as if the order will be ready sooner or later than last expected.

The smart card access management system 156 includes a card swipe or reader device and smart card access validation. The user 102 is able to pick up the item from the centralized automated delivery system for the particular order by swiping an access card, driver's license, or other card to open a box which is assigned to the item. In different embodiments, user identification may be through a tap of the user phone against an NFC reader device, use of Bluetooth communication, or other suitable means.

The card swipe or reader device reads the card information and passes the information to smart card access validation. The access validation will validate the card information with the order ID and other user details associated with the box assigned by the barcode reader system 152. The system will allow the user to pick up the item from the centralized delivery system when the order details match with card information, such as by electronically unlocking the locker or storage box. The system may also detect when the item is removed or picked up, such as when the locker is opened or a sensor/scale detects when the item is removed. The user may be sent a notification that the order has been picked up.

Payment provider server 180 may be maintained, for example, by an online payment service provider which may provide payment between user 102 and the operator of merchant server 140. In this regard, payment provider server 180 includes one or more payment applications 182, which may be configured to interact with user device 120 and merchant server 140 over network 160 to facilitate the purchase of goods or services and/or pick up of the purchase by user 102 of user device 120.

Payment provider server 180 also maintains a plurality of user accounts 184, each of which may include account information 186 associated with individual users. For example, account information 186 may include private financial information of users of devices such as account numbers, passwords, device identifiers, user names, phone numbers, credit card information, bank information, or other financial information which may be used to facilitate online transactions by user 102. Account information 186 may also include information associated with the payment and order pick-up process described herein. Advantageously, payment application 182 may be configured to interact with merchant server 140 on behalf of user 102 during a transaction with checkout application 146 to handle payments.

A transaction processing application 190, which may be part of payment application 182 or separate, may be configured to receive information from user device 120 and/or merchant server 140 for processing and storage in a payment database 192. Transaction processing application 190 may include one or more applications to process information from user 102 and/or the merchant server 140 for processing a transaction from user device 120 as described herein. Payment application 182 may be further configured to determine the existence of and to manage accounts for user 102, as well as create new accounts if necessary, such as the set-up, management, and provide various services.

Order management system 194 receives orders from user device 120, transmits the orders to the merchant server 140, and receives container identifiers from the automated delivery system 150. Order management system 194 coordinates and processes orders between the user device 120, the merchant server 140, and the automated delivery system 150. In various embodiments, order management system 194 saves information associated with the order.

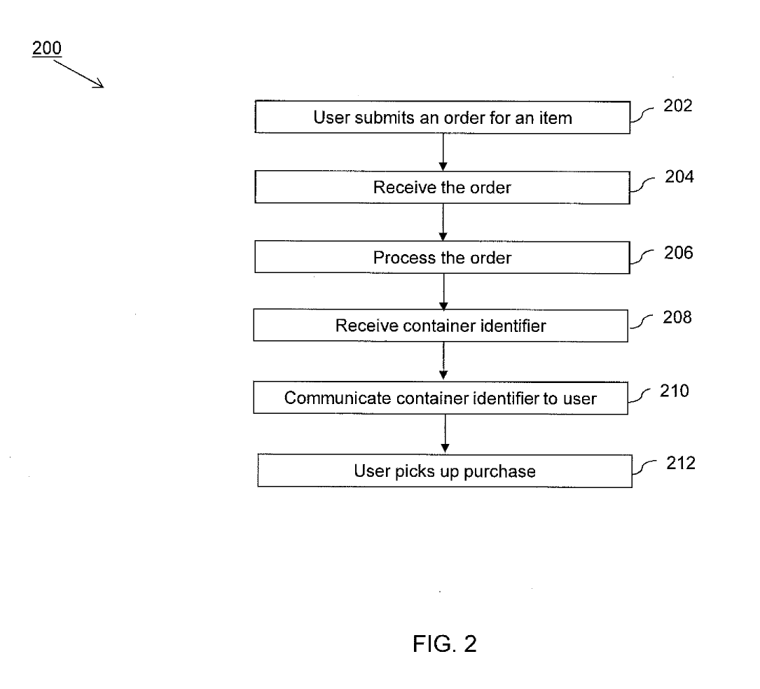

Referring now to FIG. 2, a flowchart of a method 200 for automated delivery is illustrated according to an embodiment of the present disclosure. In an embodiment, at step 202, the user 102 submits an order for an item to the payment provider server 180. For example, the user 102 first accesses a mobile app or an online site to order food or other items for purchase and pick-up. The order can also be made through a kiosk. The user 102 selects the item(s) and makes a payment, such as through a payment provider or service provider. A confirmation may be sent to the user 102.

At step 204, the payment service provider 180 receives the order. At step 206, the payment service provider 180 processes the order, such as by assigning an order ID to the order, deducting the amount of the purchase from the user 102's account, and forwarding the order to the merchant server 140.

The order is communicated to the merchant server 140, which in this example, is a restaurant or café. The restaurant receives the order and begins preparing the food. Once ready, the food is placed into a container, tray, or other holding device. The order is associated with a unique identifier for the container or the “container identifier.” For example, the container may have a barcode associated with the order. The container is placed or moved to a specific location, such as a specific locker within a set of lockers. The locker information is associated with the container and order.

The barcode reader and display management system 152 reads the container identifier from the container. At step 208, the payment service provider server 180 receives the container identifier. In various embodiments, the barcode reader and display management system 152 gets information about the order from the order management system 194. For example, the barcode reader and display management system 152 confirms that the correct amount of items are in the container. In some embodiments, the barcode reader and display management system 152 may display the user name in the corresponding order container, send and save the associated container details in the order management system 194, and/or inform the email system 154 that the order is ready for pick-up.

Email system 154 receives the pick-up container details based on the order ID and pulls the information from the order management system 152. Email system 154 may then send an email to the user 102 with the pick-up container details. Alternatively, email system 154 may transmit a message to order management system 194, and order management system 194 may send the email.

At step 210, the container identifier is communicated to the user 102. For example, an email, text, or voice message is sent to the user 102, such as on the user device 120, with details of the order and its status. In one example, the user 102 is notified that the order is ready and can be picked up now. In another embodiment, the user 102 is notified of the time the order will be ready for pick-up. In this example, the notification is sent before the order is ready. Thus, while the order is being prepared, an estimate of when the order will be ready is determined, along with the container identification and location information for the order.

The notification may include details of the order, such as description, price, order location, order number or ID, how to pick up the order, etc. For example, the notification may include a map or other visual indicator of a building or address. The notification may include a box or container number in the building and instructions to pick up the item by entering in a code, entering the order number, scanning a card, tapping a phone, etc. These instructions may also be at the pick-up location.

At step 212, the user 102 picks up the order. Once at the pick-up location, the user 102 may see an assortment of lockers with numbers. The user's notification would have a number that matches with one or more of the lockers, indicating the locker(s) where the user 102 can pick up the item(s). The lockers may also include a more readily discernible identifier, such as an electronic display of the user's name (first name and/or last time), phone number, etc. These lockers may be locked, with access granted by the user 102 entering or communicating some sort of acceptable identification information. Examples include manual entry of a code, a swipe of a driver's license, credit card, bank card, an employee ID card, or other suitable card, and/or tapping a user smart phone with a reader to communicate user identification information through NFC or Bluetooth.

In an example, the user 102 swipes the card in the appropriate container, based on the order pick up confirmation email with pick-up container details. The smart card access management system 156 then processes the received user information to determine whether the information matches what is expected for the order associated with the particular locker(s). If so, the locker door is unlocked to allow the user 102 to pick up the item(s). If the information cannot be matched, the user 102 may be sent an email, text, or voice message to try again or with order pick up information again. The locker may also display information that access is not granted and for the user 102 to confirm the locker location and any other necessary information, such as the locker code.

When the item is picked up, the smart card access management system 156 may close out the order and the user 102 and/or merchant may be sent a notification that the order is now completed.

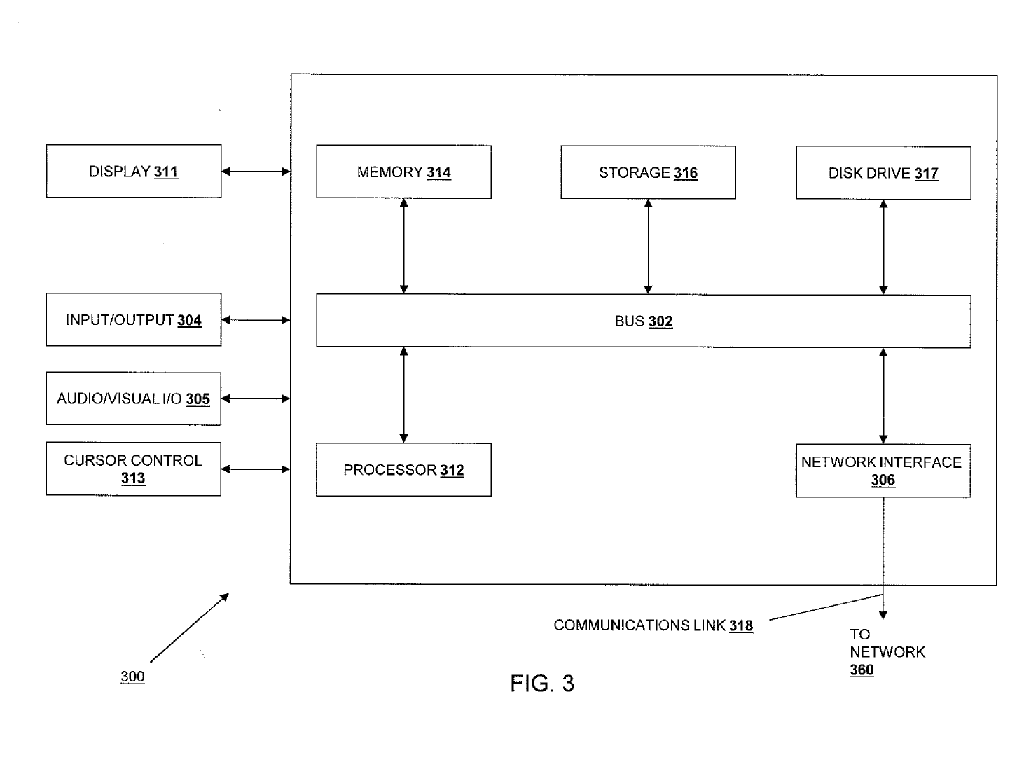

FIG. 3 is a block diagram of a computer system 300 suitable for implementing one or more embodiments of the present disclosure. In various implementations, the user device 102 may comprise a personal computing device (e.g., a personal computer, laptop, smart phone, tablet, PDA, Bluetooth device, key FOB, badge, etc.) capable of communicating with the network. The merchant server 140, automated delivery system 150 and/or payment provider server 180 may utilize a network computing device (e.g., a network server) capable of communicating with the network 160. It should be appreciated that each of the devices utilized by users, merchants, service providers, and payment providers may be implemented as computer system 300 in a manner as follows.

Computer system 300 includes a bus 302 or other communication mechanism for communicating information data, signals, and information between various components of computer system 300. Components include an input/output (I/O) component 304 that processes a user action, such as selecting keys from a keypad/keyboard, selecting one or more buttons or links, etc., and sends a corresponding signal to bus 302. I/O component 304 may also include an output component, such as a display 311 and a cursor control 313 (such as a keyboard, keypad, mouse, etc.). One or more optional audio/video (A/V) input/output (I/O) components 305 may also be included to allow a user to use voice and/or video for inputting information by converting audio signals. A/V I/O component 305 may allow the user to hear audio. A transceiver or network interface 306 transmits and receives signals between computer system 300 and other devices, such as another user device, a merchant server, an automated delivery system, or a payment provider server via network 160. In one embodiment, the transmission is wireless, although other transmission mediums and methods may also be suitable. A processor 312, which can be a micro-controller, digital signal processor (DSP), or other processing component, processes these various signals, such as for display on computer system 300 or transmission to other devices via a communication link 318. Processor 312 may also control transmission of information, such as cookies or IP addresses, to other devices.

Components of computer system 300 also include a system memory component 314 (e.g., RAM), a static storage component 316 (e.g., ROM), and/or a disk drive 317 to store information, such as account information, transaction numbers, order numbers, container identifiers, access codes, machine IDs, and other information described above. Computer system 300 performs specific operations by processor 312 and other components by executing one or more sequences of instructions contained in system memory component 314. Instructions may be performed by one or more processors 312. Logic may be encoded in a computer readable medium, which may refer to any medium that participates in providing instructions to processor 312 for execution. Such a medium may take many forms, including but not limited to, non-volatile media, volatile media, and transmission media. In various implementations, non-volatile media includes optical or magnetic disks, volatile media includes dynamic memory, such as system memory component 314, and transmission media includes coaxial cables, copper wire, and fiber optics, including wires that comprise bus 302. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 300. In various other embodiments of the present disclosure, a plurality of computer systems 300 coupled by communication link 318 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more machine readable mediums, including non-transitory machine readable medium. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

Embodiments described herein are exemplary only. One skilled in the art may recognize various alternative embodiments from those specifically disclosed. Those alternative embodiments are also intended to be within the scope of this disclosure. As such, the embodiments are limited only by the following claims.

What is claimed is:

1. A system comprising:
a memory storing information about user accounts, wherein the information comprises order information associated with a purchase order for pick-up; and
one or more hardware processors in communication with the memory, wherein the one or more processors is configured for:
receiving, by a service provider, an order of at least one item with a merchant for pick-up by a user;
processing the order;
receiving a container identifier that corresponds to a container containing the at least one item; and
communicating the container identifier to the user, wherein the user communicates information associated with the order to the container containing the at least one item to pick up the at least one item.

2. The system of claim 1, wherein the information is a user identifier.

3. The system of claim 2, wherein the user identifier is contained in a user card that is read by a device associated with the container.

4. The system of claim 3, wherein the user card comprises a driver's license, an employee card, a credit card, or a bank card.

5. The system of claim 1, wherein the container identifier is communicated to the user when the at least one item is placed in the container, or to the user prior to the at least one item being placed in the container.

6. The system of claim 5, wherein a time for pick-up is included with the container identifier.

7. The system of claim 1, wherein the container includes a barcode containing information associated with the order or the at least one item.

8. The system of claim 1, wherein the container identifier is further associated with the at least one item in the container and with the order.

9. A method for automated delivery, comprising:
receiving, by a hardware processor of a service provider, an order of at least one item with a merchant for pick-up by a user;
processing the order;
receiving a container identifier that corresponds to a container containing the at least one item; and
communicating, electronically by the hardware processor, the container identifier to the user, wherein the user communicates information associated with the order to the container containing the at least one item to pick up the at least one item.

10. The method of claim 9, wherein the information is a user identifier.

11. The method of claim 10, wherein the user identifier is contained in a user card that is read by a device associated with the container.

12. The method of claim 11, wherein the user card comprises a driver's license, an employee card, a credit card, or a bank card.

13. The method of claim 9, wherein the container identifier is communicated to the user when the at least one item is placed in the container or prior to the at least one item being placed in the container.

14. The method of claim 13, wherein a time for pick-up is included with the container identifier.

15. The method of claim 9, wherein the container includes a barcode containing information associated with the order or the at least one item.

16. A non-transitory machine-readable medium comprising a plurality of machine-readable instructions which when executed by one or more processors of a server are adapted to cause the server to perform a method comprising:
receiving, by a service provider, an order of at least one item with a merchant for pick-up by a user;
processing the order;
receiving a container identifier that corresponds to a container containing at least one item from the purchase; and
communicating the container identifier to the user, wherein the user communicates information associated with the order to the container containing the at least one item to pick up the at least one item.

17. The non-transitory machine-readable medium of claim 16, wherein the information is a user identifier.

18. The non-transitory machine-readable medium of claim 17, wherein the user identifier is contained in a user card that is read by a device associated with the container.

19. The non-transitory machine-readable medium of claim 18, wherein the user card comprises a driver's license, an employee card, a credit card, or a bank card.

20. The non-transitory machine-readable medium of claim 16, wherein the container identifier is communicated to the user when the at least one item is placed in the container or prior to the at least one item being placed in the container.
